(19) United States
(12) Patent Application Publication
(10) Pub. No.: US 2014/0126879 A1
(43) Pub. Date: May 8, 2014

(54) METHOD FOR CONTROLLING A MEMORY INTERFACE AND ASSOCIATED INTERFACE

(71) Applicants: Nicolas Marce, Bruz (FR); Alain Tritschler, Rennes (FR)

(72) Inventors: Nicolas Marce, Bruz (FR); Alain Tritschler, Rennes (FR)

(73) Assignee: THOMSON LICENSING, Issy de Moulineaux (FR)

(21) Appl. No.: 14/006,723

(22) PCT Filed: Mar. 23, 2012
(86) PCT No.: PCT/EP12/55160

§ 371 Date: Dec. 3, 2013

(30) Foreign Application Priority Data
Mar. 25, 2011 (FR) 1152425

(51) Int. Cl. H04N 5/765

(52) U.S. Cl. CPC H04N 5/765
USPC 386/231

(57) ABSTRACT

The inventions relates to a method for controlling an interface providing the connection between a device suitable for the recording and reading of data such as a receiver/decoder of audio-visual programs and an external memory. The method comprises the steps for detecting the type of external memory connected to the external memory interface and for authorising write access to the external memory according to the type of memory detected, the available storage capacity and the total capacity of the external memory.

### 1. SCOPE OF THE INVENTION

The invention relates to the domain of receivers/recorders of video programs and more specifically to the recording of data that comprise the programs on a removable peripheral device.

### 2. PRIOR ART

The video receivers/recorders still called PVR, for “Personal Video Recorder” offer the user the possibility of viewing a program broadcast in real time with a slight delay or apply a pause in viewing the program while the broadcasting continues and then start viewing again with a slight delay. This possibility enables the user to interrupt the viewing of the program without, however, losing its content in terms of viewing. This functionality is based on the recording of the program on a backup unit, at the same time as the viewing. As soon as the recording of the program has begun, and during the viewing of the latter, the user can interrupt the viewing by activating a pause command. During the pause, the recording continues. When the user begins to view the program again, by activating a play command, the program is simultaneously read and recorded on the backup unit. This function is commonly called “time-shift”. The backup unit used can be a random access memory or a mass storage. Considering the storage capacities required for recording video programs and the access time to the backup unit, the backup means used is more generally a hard disk. Recent techniques used for the memory cells of the backup units nevertheless allow rapid read and write accesses as well as sufficient capacities for recording video programs. It is now possible to record many programs on a non-volatile, rewritable, flash technology memory. Moreover, these memories have small dimensions and can be carried easily by the user from one recorder to another or from a recorder to a computer for example. The connection type is generally standardised, which makes it easy to transfer or exchange data to or from one device to another. Many removable memories take the shape of a USB key (Universal Serial Bus) that contains flash technology integrated circuits. Hence, reception and recording devices having a USB connection interface and enabling the connection of a non-volatile and removable memory have appeared on the market. In the context of a receiver/recorder of video programs, it is now possible to realize the “time-shift” function by recording a program received and by rereading it simultaneously on a flash technology USB key. The “time-shift” function of a receiver/recorder can thus be realized by means of an internal hard disk, an external hard disk or a USB key. Other functions are made accessible to the user owing to the use of a backup unit and the recording of the program during its broadcast. The user can, for example, rewind, freeze the frame, play a chosen portion of the program, fast rewind or forward to rapidly locate a portion of the program he wishes to see again. These different modes are commonly called “trick modes”.

Although the possibility of using a removable memory of the flash memory type provides an ease of use and a simplicity of implementation for the user, it has a disadvantage. The flash type memory cells have a limited number of write cycles. There is a phenomenon of wear on the flash memory cells. This represents a disadvantage as the “time-shift” function requires a systematic recording of the program viewed and carries out a large number of simultaneous read and write accesses (and therefore in writing). The systematic recording of a viewed program with a view to allow the use of the “time-shift” function gradually degrades the backup unit, which ultimately becomes inoperative.

### 3. SUMMARY OF THE INVENTION

The purpose of the invention is to overcome at least one of the disadvantages of the prior art and more specifically to prevent the recording of the broadcast and viewed program from being carried out systematically (with a view to enabling time-shift) if the memory type used for the recording can be prematurely degraded by this.

More particularly, the invention relates to a method for controlling an interface providing the connection between a suitable device for the recording and reading of data and an external memory, characterized in that the method comprises, in the device, the steps for detecting the type of external memory connected to the interface and for authorizing write access to the external memory according to the type of external memory detected and the available storage capacity on said external memory.

According to an embodiment of the invention, the detection step comprises a step for reading at least one information field in the external memory.

According to an embodiment of the invention, the at least one information element read in the external memory indicates whether the external memory is of the flash type.

According to an embodiment of the invention, the authorisation for write accesses to the external memory further depends on an identifier compared with a list of identifiers.

According to an embodiment of the invention, the authorisation for write accesses to said external memory further depends on a configurable parameter.

According to an embodiment of the invention, the authorisation for write accesses to said external memory further depends on the storage capacity of said external memory.

According to an embodiment of the invention, the write access is refused when the external memory is of the flash type.

According to an embodiment of the invention, the method further comprises a step for redirecting write accesses to an internal memory of the device.

According to an embodiment of the invention, the device is a receiver/decoder of audiovisual programs.

According to an embodiment of the invention, the detection and authorisation steps are performed at each new connection of the external memory.

According to an embodiment of the invention, the detection and authorisation steps are carried out for each change of program received and viewed by said device.

According to an embodiment of the invention, the write accesses are generated by a “time-shift” function.

The invention also relates to a device suitable for the recording and reading of data comprising interfacing means for the connection of an external memory, characterized in that the device comprises means for detecting the type of external memory connected and means for authorising write access to the external memory according to the external memory type detected and the available storage capacity (size) of the external memory.

According to an embodiment of the invention, the means for authorising access to the device are configured by write operations in a configuration field.

### 4. LIST OF FIGURES

The invention will be better understood, and other specific features and advantages will emerge upon reading the following description, the description making reference to the annexed drawings wherein:

FIG. 1 illustrates a system according to a particular embodiment of the invention,

FIG. 2 diagrammatically illustrates, respectively, a reception and decoding device suitable for the recording and reading of audiovisual programs comprising an external memory interface controlled according to an embodiment of the invention.

FIG. 3 is a diagram illustrating the method according to an embodiment of the invention.

### 5. DETAILED DESCRIPTION OF THE INVENTION

Generally but not restrictively, the invention relates to a method for controlling an external memory interface.

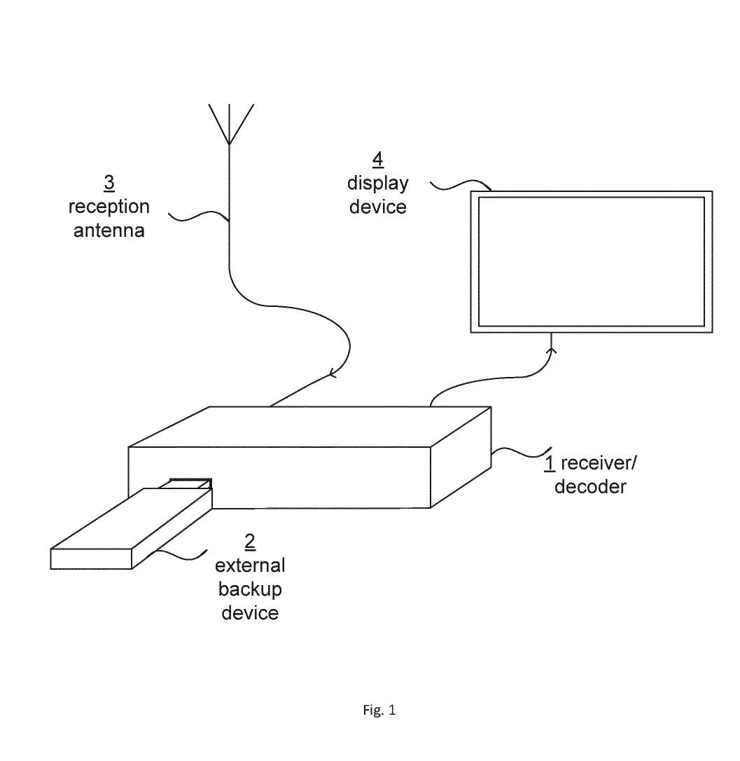

FIG. 1 illustrates a system for receiving audiovisual programs by means of a receiver/decoder according to an embodiment of the invention. The receiver/decoder 1 is a Personal Video Recorder (PVR) that captures the signals that code audiovisual programs by means of the reception antenna 3. The signals are decoded by the receiver/decoder 1 that delivers output signals to the display device 4 for the recovery of the audiovisual programs. An external backup unit can be connected to the receiver/decoder 1 to enable the recording and playing of the received programs. When an audiovisual program is selected, upon start-up of the receiver/decoder or following a channel change, the program is recorded on the external backup unit 2 (also called external memory) while being viewed. It is then possible to replay portions of the program recorded between the start of the recording and the rewind command. During any playing of one or more recorded portions, the recording of the program continues. Read and write accesses are carried out on the external backup unit 2.

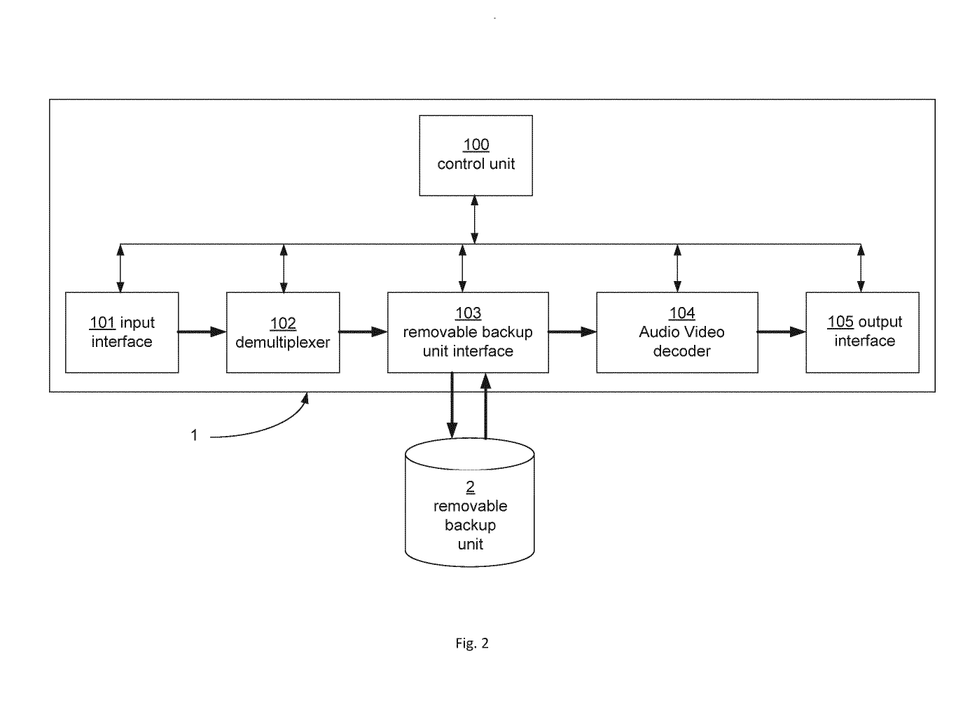

FIG. 2 illustrates a decoder/receiver 1 enabling the reception and viewing of audiovisual programs and suitable for the recording and playing of data that constitute the audiovisual programs on an external backup unit 2 also called external memory. The decoder/receiver 1 is adapted to operate as a Personal Video Recorder (PVR). The signals that code the programs are received by the input interface 101 that processes them to convert them into a data stream delivered to the demultiplexer 102. The data received can correspond to several audiovisual programs, the demultiplexer 102 extracts the data corresponding to the program selected to be viewed. The demultiplexer 102 thus supplies the data extracted from the removable backup unit interface 103. The path of the data in the interface 103 varies according to the functions activated. During real time viewing (or direct), the interface 103 delivers the data stream corresponding to the program viewed, coming from the demultiplexer 102, to the audio/video decoder 104 that decodes the data with a view to delivering, at the output interface 105, signals compatible with a display device (not shown) connected to the receiver/decoder 1.

When the time-shift function is activated, the removable backup unit interface also directs the data stream from the demultiplexer 102 to the removable backup unit 2. As long as no time-shift function has been implemented (play after rewind, play after pause, play from the start of the recording), the data stream is delivered simultaneously to the external backup unit 2 and the audio/video decoder 104 via the interface 103.

As soon as a time-shift function has been used, there is an delay between the program broadcast and its viewing. The data stream sent by the interface 103 to the decoder 104 is read from the unit 2 while the recording takes place with a data stream from the demultiplexer 102.

The functional elements that constitute the decoder are controlled by the control unit 100. The control unit 100 configures the configuration registers of the different elements and further enables the execution of software applications by the receiver 1.

According to one embodiment of the invention, and when a removable backup unit 2 is connected to the receiver/decoder 1, the interface 103 detects the connection and sends a notification to the control unit 100. The control unit responds to this notification by performing a read operation of the information field (for example one or more registers) of the removable backup unit, through the interface 103.

According to one embodiment of the invention, one of the registers read enables the control unit to know the type of removable backup unit and to define, particularly, whether the memory cells are constituted from flash technology. In the case where a unit 2 of the flash memory type is detected, the control unit 100 configures the interface 103 to prohibit the write accesses so as to prevent premature wear of the memory cells of the unit 2.

According to one embodiment of the invention, it is possible to authorise the use of the unit 2, irrespective of the memory type, according to a parameter configurable by the user. The user positions this parameter by means of a user interface, such as a configuration menu displayed on a display device connected to the output interface 105. The menu enables the user to select an option to authorise the accesses when a flash type memory is detected. In the absence of this option, if a flash type memory is detected, the interface directly delivers the flow of data from the demultiplexer 102 to the decoder 104. The time-shift function is therefore inhibited as soon as a delay between the reception of a program and its viewing, giving rise to accesses on a unit 2 of the flash type, is necessary.

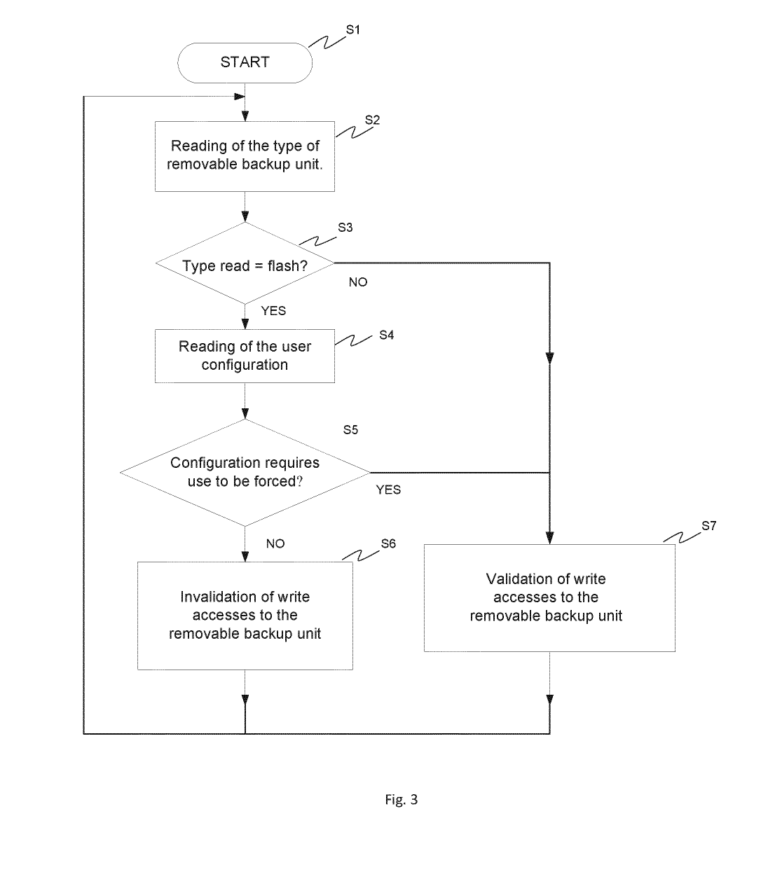

FIG. 3 is a block diagram which illustrates the method. Step S1 represents the initialisation when the connection of a removable backup unit is detected. During step S2, the control unit of the decoder performs a read operation of an information field containing the memory type used. At step S3, if the memory detected is not of the flash type, the control unit configures the removable backup unit interface at step S7 so that the write accesses to the removable backup unit are authorised. At step S3, if the memory type used is of the flash type, the control unit of the receiver/decoder reads the configurable parameter at the step S4 and configures the interface of the backup unit according to the parameter. If the parameter indicates that the accesses must be write authorised although the memory is of the flash type, the step S7 is performed and the write accesses are authorised. If the configurable parameter does not indicate that it is requested to authorise the accesses to the flash memory, the interface of the backup unit is configured at S6 so as to prohibit these accesses.

According to one embodiment of the invention, the reading of the memory type connected, as well as the configuration steps of the interface of the backup unit can take place at each change of program viewed (change of channel) since a change of program viewed initiates a new recording so as to enable subsequent use of the time-shift function and a possible return to a portion of the program.

Advantageously, the reading of the memory type connected, as well as the configuration steps of the interface of the backup unit can take place at each new connection of an external memory to the interface.

According to one embodiment of the invention, the authorization of accesses to the flash memory depends on the type of memory and on the storage capacity available in the external memory and depends, for example, on a threshold or a ratio configured automatically or by the user. The threshold/ratio is defined between the available storage size on the external memory and the total storage size of the external memory. If the available storage capacity is very sizeable in relation to the quantity of data stored during the use of the “time-shift” function, the accesses are authorized. The threshold can be defined automatically, for example, by the control unit of the PVR depending on the overall storage size detected of the external memory. It can be set to 50% for example, if the overall storage size of the external memory is inferior or equal to 16 Giga-bytes and can be less, such as 30% for example if the overall storage size of the external memory is more than 16 Giga-bytes. In a variant, the threshold, such as a percentage of the overall storage size of the external memory that is free for recording is set by the user through the use of a dedicated setup menu available in the user interface of the PVR. In other words, if the control unit detects, for example, that the overall storage size of the external memory is 32 Giga-bytes and that there is at least 30% of these 32 Giga-bytes free and available for recording, then the write accesses are authorized.

According to another embodiment, only a part of the external memory is usable for trick modes and read/write access related to the recording functions of the PVR and is defined as reserved for such a recording use thanks to a set-up procedure, through a set-up menu, when the external memory device is connected to the PVR device.

According to a preferred embodiment, the removable backup unit is a memory of the flash type constituted by a printed circuit carrying one or more memory circuits constituted from flash memory cells and which interconnects with the device by means of a standard interface of the USB (Universal Serial Bus) type.

The invention also relates to the external backup units that interconnect with any other type of electric and mechanical interface such as, for example, the IEEE1394, the Ethernet, the SD and microSD type memory cards and more generally any removable non-volatile memory.

1. Method for controlling an interface providing the connection between a device suitable for the recording and reading of data and an external memory, wherein the method comprises the following steps in said device:
detection of the type of said external memory connected to said interface,
authorization for write access to said external memory according to the type of said external memory detected and according to a ratio between the available storage size on said external memory and the total storage size of said external memory.

2. Method according to claim 1 wherein the detection step comprises a step for reading at least one information element in said external memory.

3. Method according to claim 1 wherein at least one information element read in said external memory indicates whether said external memory is of the flash type,

4. Method according to claim 1, wherein the authorisation for write accesses to said external memory further depends on an identifier compared with a list of identifiers.

5. Method according to claim 1, wherein the authorisation for write accesses to said external memory further depends on a configurable parameter.

6. Method according to according to claim 1, wherein write access is refused when the external memory is of the flash type if said ratio is below a predetermined threshold.

7. Method according according to claim 1, wherein the method further comprises a step for redirecting said write accesses to an internal memory of said device.

8. Method according to claim 1, wherein said device is a receiver/decoder of audiovisual programs.

9. Method according to claim 1, wherein said detection and authorisation steps are performed at each new connection of the external memory.

10. Method according to claim 1, wherein said detection and authorisation steps are carried out for each change of program received and viewed by said device.

11. Method according to claim 1, wherein said write accesses are generated by a time-shift function.

12. Device suitable for the recording and reading of data comprising interfacing means for the connection of an external memory, wherein said device comprises means for detecting the type of external memory connected and means for authorising write access to the external memory according to the external memory type detected and according to a ratio between the available storage size on said external memory and the total storage size of said external memory.

13. Device according to claim 12, wherein the means for authorising access are configured by a write operation on a configuration field.
